(19) United States
(12) Patent Application Publication
(10) Pub. No.: US 2005/0200183 A1
(43) Pub. Date: Sep. 15, 2005

(54) Automobile seat system including a backrest inclination measuring device

(76) Inventors: Laurent Morinet, Neuilly Plaisance (FR); Herve Dirand, Valentgney (FR)

Correspondence Address: BACHMAN & LAPOINTE, P.C., 900 CHAPEL STREET, SUITE 1201, NEW HAVEN, CT, 06510, US

(21) Appl. No.: 11/068,670

(22) Filed: Feb. 28, 2005

(30) Foreign Application Priority Data
Mar. 1, 2004 (FR) 0402070

(51) Int. Cl. B60N 2/02

(52) U.S. Cl. 297/354.1

(57) ABSTRACT

The automobile seat system includes a backrest inclination measuring device which includes a first absolute inclination sensor fixed in relation to the backrest and a second absolute inclination sensor fixed in relation to a reference element and a computer to deduce by difference the inclination of the backrest in relation to the reference element. Application for determining the relative inclination of the backrest of an automobile vehicle seat in relation to the floor or to the seat pan of the vehicle.

### BACKGROUND OF THE INVENTION

(1) Field of Invention

The present invention relates to an automobile seat system including a backrest inclination measuring device.

(2) Prior Art

Devices intended to measure the inclination angle of the backrest in relation to the seat pan are already known.

These systems are especially intended for electrically controlled seats with position memorisation and also to adapt the power of the inflatable safety cushions, commonly known as “air-bags”, according to the interior configuration of the vehicle and its occupants, this power being adaptable for example according to the inclination of the backrests which influences the distance between the user of the seat and the steering wheel of the vehicle, etc.

Some systems use potentiometric sensors placed at the level of the hinges between the backrest and seat pan. These systems can only give the inclination of the backrest in relation to the seat pan and not in relation to the floor of the vehicle when the inclination and/or height of the seat pan is itself adjustable, because it is then difficult to measure the angle of the said seat pan in relation to the floor. In addition, the reliability of potentiometers is sometimes tricky to ensure in use.

Hall effect sensors can also be used but these sensors are expensive.

Other systems use sensors counting the number of turns of the control motor shaft but they can only be used on electrically adjustable seats and the problems of measuring backrest inclination in relation to the floor remain.

### SUMMARY OF THE INVENTION

It is an object of the present invention to solve these problems and, in particular, to enable both the inclination of the backrest in relation to the floor of the vehicle and the angle between the seat pan and the backrest to be easily and reliably determined. The object of the present invention is also to provide a system where installation on the seat is very simple and does not require operations on the framework of the backrest or the seat pan and/or modifications to the mechanical hinge between backrest and seat pan.

With these targets in mind, the subject of the invention is an automobile seat system including a backrest inclination measurement device wherein this device includes a first absolute inclination sensor fixed in relation to the backrest and a second absolute inclination sensor fixed in relation to a reference element and a computer to deduce by difference the inclination of the backrest in relation to the reference element.

An absolute inclination sensor means a sensor capable of measuring an angle between a general orientation of the sensor, which can be located in the plane in which the said sensor is fixed, and the vertical direction, defined by the line of gravitational force.

Preferably, the absolute inclination sensors will be accelerometers capable of measuring this angle with an accuracy sufficient for the targeted application. The accuracy of the final system, including the measurement and the processing of the data, will be around 1 to 2 angular degrees.

According to a specific arrangement, the second absolute inclination sensor is fixed in relation to the floor of the vehicle. In this case, it will be possible to directly obtain the inclination of the backrest in relation to the floor of the vehicle which will be useful for example for giving the inflatable safety cushion control computer an indication on the inclination of the backrest and therefore on the distance between the user of the seat and the module including the said cushion by combining this inclination indication with an indication on the longitudinal position of the seat pan in the vehicle, said longitudinal position being obtained by other sensors. In this arrangement, in addition to the accuracy in determining inclination angles, the device according to the invention has good stability and especially overcomes possible variations in the inclination of the seat pan.

According to another arrangement, the second absolute inclination sensor is fixed in relation to the seat pan. In this case, the inclination of the backrest in relation to the seat pan will be obtained directly and the value of this angle can be used for electrically controlled seat adjustment memory systems. If the attitude of the seat pan is fixed in relation to the floor, this embodiment can also be used to define the inclination of the backrest in relation to the said floor.

According to an additional arrangement, usable when the inclination of the seat pan is adjustable, for example in the conventional case of a non-parallel seat pan raising system, a third absolute inclination sensor can be added. Depending on whether the second sensor is fixed in relation to the floor or to the seat pan, this third sensor will be fixed therefore in relation to the seat pan or the floor of the vehicle. It will then be possible to measure all required angles of the seat pan and of the backrest in relation to each other or in relation to the floor.

The invention will be more readily understood on reading the following description relevant to a seat system in compliance with the invention for determining the inclination of the backrest in relation to the floor of the vehicle.

### BRIEF DESCRIPTION OF THE DRAWINGS

Refer to the appended drawings in which:

FIG. 1 is an overall view of a seat equipped with an absolute inclination sensor in the backrest and another on the seat pan longitudinal guide rails,

FIG. 2 schematically illustrates how the inclination of the backrest in relation to the floor of the vehicle is determined, which is possible by the device according to the invention independent of the slope of the route on which the vehicle is located,

FIG. 3 is a block diagram showing the calculation of the angle of inclination of the backrest in relation to the floor of the vehicle.

### DETAILED DESCRIPTION OF THE PREFERRED EMBODIMENT(S)

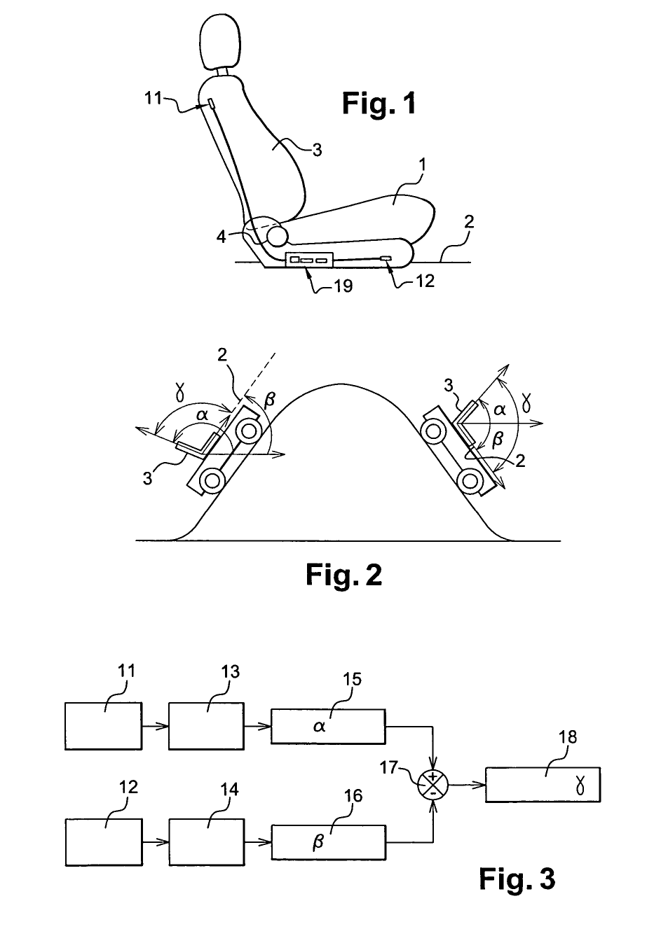

As can be seen on FIG. 1, the seat includes a seat pan 1 installed so as to slide on the floor of the vehicle on guide rails 2. The backrest 3 is installed on the seat pan by a hinge 4 allowing its inclination to be adjusted in relation to the seat pan.

A first accelerometer 11 is attached to the backrest 1 and a second accelerometer 12 is attached to one of the guide rails of the seat pan. The first accelerometer delivers a signal representative of the absolute inclination of the backrest in relation to the vehicle and the second accelerometer delivers a signal representative of the inclination of the slide and therefore of the floor and of the vehicle as a whole.

Such accelerometers are for example marketed under reference SCA61T by VTI Technologies.

The two accelerometers are connected to a computer 19 which is represented here onboard the seat but which could also be placed elsewhere in the vehicle.

To obtain sufficient accuracy for the measurements made by the accelerometers, the signals delivered by the accelerometers must be processed to eliminate the components of these signals resulting from the vibrations of the car as it runs. Preferably, a low-pass filter will be used to eliminate the frequencies due to the vehicle itself or to running conditions such as the condition of the road.

It has been observed that an accuracy of 1 angular degree could be obtained with a filter with a cutoff frequency of 0.01 Hz but, with such a filter, the response time of the system may be excessively lengthened. With a cuttof frequency of 0.1 Hz, the accuracy was around 2° which can be sufficient.

As can be seen on the diagram of FIG. 3, such low-pass filters 13, 14 are placed downstream of the accelerometers to respectively deliver signals representative of angular values 15, 16 of the absolute inclinations of the backrest and of the floor. These signals are fed to a comparator 17 which calculates the difference to deliver the relative value 18 of the inclination of the backrest in relation to the floor.

FIG. 3 schematically represents the vehicle on a portion of climbing road and on a portion of descending road. The angles of inclination, α and β, measured by the accelerometers, respectively of the backrest and of the floor in relation to the horizontal, which is equivalent to an absolute measurement in relation to the vertical, are given in each case. It is easy to understand that algebraic subtraction gives the relative angle of inclination γ of the backrest in relation to the floor and this irrespective of the inclination of the vehicle.

The invention is not limited to the embodiment described above only as an example. The arrangement and the location of the accelerometers can be adapted to each case and a third accelerometer can be attached for example to the seat pan to measure in a similar manner the angle between the seat pan and the backrest or between the seat pan and the floor.

1-6. (canceled)

7. Automobile seat system including a backrest inclination measuring device wherein the device includes a first absolute inclination sensor fixed in relation to the backrest and a second absolute inclination sensor fixed in relation to a reference element and a computer to deduce by difference an inclination of the backrest in relation to the reference element.

8. Automobile seat system according to claim 7, wherein each of the absolute inclination sensors is and accelerometer.

9. Automobile seat system according to claim 7, wherein the second absolute inclination sensor is fixed in relation to a floor of a vehicle.

10. Automobile seat system according to claim 7, wherein the second absolute inclination sensor is fixed in relation to a seat pan.

11. Automobile seat system according to claim 9, further including a third absolute inclination sensor.

12. Automobile seat system according to claim 7, wherein signals delivered by each said sensor are processed by low-pass filters.
